(19) United States
(12) Patent Application Publication
(10) Pub. No.: US 2017/0110799 A1
(43) Pub. Date: Apr. 20, 2017

(54) Antenna Systems for Wireless Sensor Devices

(71) Applicant: Cognitive Systems Corp., Waterloo (CA)

(72) Inventors: Hamed Holisaz, Waterloo (CA); Yang Ling, Waterloo (CA)

(73) Assignee: Cognitive Systems Corp., Waterloo (CA)

(21) Appl. No.: 14/883,432

(22) Filed: Oct. 14, 2015

(51) Int. Cl. H01Q 9/04; H01Q 1/38

(52) U.S. Cl. CPC H01Q 9/0407; H01Q 1/38

(57) ABSTRACT

In a general aspect, an antenna array system includes an array of monopole antennas. In some implementations, the antenna array system includes a planar substrate having a substrate surface, a ground plane residing on the substrate surface, feeds residing on the substrate surface and elliptical patches. The ground plane has an outer boundary and slots extending inwardly from the outer boundary. Each of the slots includes slot sides that define an interior region of the slot. The feeds reside in the slots and are separated from the ground plane by a gap. Each of the feeds extends from a first end in the interior region of a respective one of the slots to a second end in an exterior area beyond the outer boundary of the ground plane. Each of the elliptical patches is coupled to a respective one of the plurality of feeds.

### BACKGROUND

The following description relates to antenna systems for wireless sensor devices.

Wireless devices use antennas to wirelessly detect and transmit signals. In many wireless communication networks, mobile device antennas operate within a spectral bandwidth allocated to the wireless communication network. For instance, cellular networks and Wi-Fi networks typically utilize an allocated portion of radio frequency spectrum.

### SUMMARY

In a general aspect of what is described here, an antenna array system includes an array of monopole antennas.

In some aspects, an antenna array system includes a planar substrate having a substrate surface, a ground plane residing on the substrate surface, feeds residing on the substrate surface and elliptical patches. The ground plane includes an outer boundary and slots extending inwardly from the outer boundary. Each of the slots includes slot sides that define an interior region of the slot. The feeds reside in the slots with a clearance space between each of the feeds and the ground plane. Each of the feeds extends from a first end in the interior region of a respective one of the slots to a second end in an exterior area beyond the outer boundary of the ground plane. Each of the elliptical patches is coupled to a respective one of the plurality of feeds.

In some aspects, a wireless sensor device includes a housing, a radio frequency signal processor system in the housing, and an antenna array system in the housing. The antenna array system is coupled to the radio frequency signal processor system and is configured to communicate wirelessly with a wireless communication network. The antenna array system includes a planar substrate that has a substrate surface. The antenna array system also includes a ground plane on the substrate surface, feeds on the substrate surface and elliptical patches. The ground plane includes an outer boundary and multiple slots extending inwardly from the outer boundary. Each of the slots includes slot sides that define an interior region of the slot. The feeds reside in the slots and form a coplanar waveguide that transfers signals between the ground plane and the elliptical patches. Each feed extends from a first end in the interior region of a respective one of the slots to a second end in an exterior area beyond the outer boundary of the ground plane. Each of the elliptical patches is conductively coupled to a respective one of the plurality of feeds.

In some aspects, an antenna array system is constructed. The antenna array system includes an array of monopole antennas. A planar substrate having a substrate surface is received. A ground plane is formed on the substrate surface. The ground plane includes an outer boundary and multiple slots extending inwardly from the outer boundary. Each of the slots includes slot sides that define an interior region of the slot. Feeds are formed on the substrate surface. The feeds reside in the slots and are separated from the ground plane by a gap. Each feed extends from a first end in the interior region of a respective one of the slots to a second end in an exterior area beyond the outer boundary of the ground plane. Elliptical patches are coupled to the feeds. Each of the elliptical patches is coupled to a respective one of the plurality of feeds.

Implementations of these and other aspects may include one or more of the following features. Each of the slots has an opening between the interior region of the slot and the exterior area, and the openings of the slots can be distributed uniformly about the outer boundary of the ground plane. Each of the elliptical patches can be a planar conductor residing on the substrate surface in the exterior area. Each of the feeds can be a planar conductor that has a width that is tapered, for example, linearly decreasing in width from the first end to the second end. The antenna array system can be configured to transmit and receive electromagnetic signals in the range of 600 MHz to 6 GHz.

Implementations of these and other aspects may include one or more of the following features. The antenna array system can include an array of exactly two monopole antennas, where each of the two monopole antennas includes one of the feeds and one of the elliptical patches. The antenna array system can include an array of exactly four monopole antennas, where each of the four monopole antennas includes one of the feeds and one of the elliptical patches. The antenna array system can include an array of exactly eight monopole antennas, where each of the eight monopole antennas includes one of the feeds and one of the elliptical patches.

The details of one or more implementations are set forth in the accompanying drawings and the description below. Other features, objects, and advantages will be apparent from the description and drawings, and from the claims. DESCRIPTION OF DRAWINGS

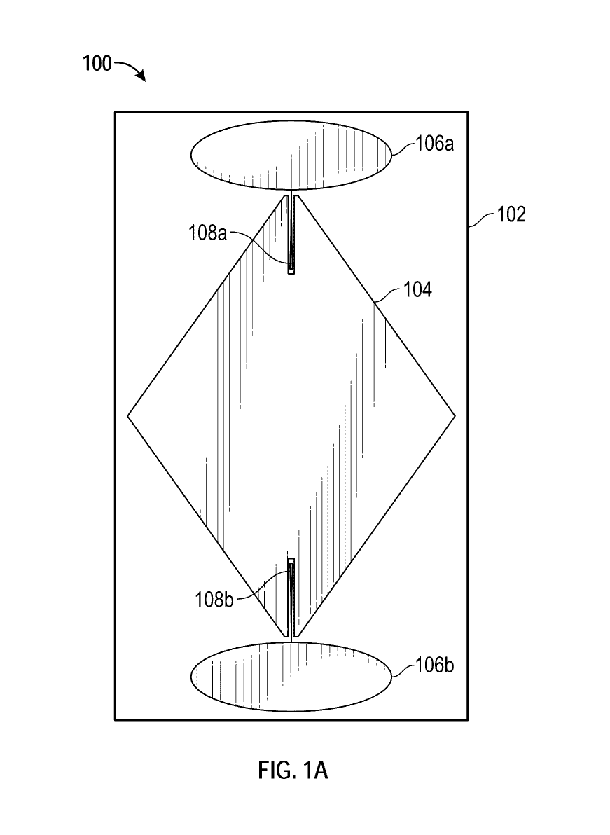

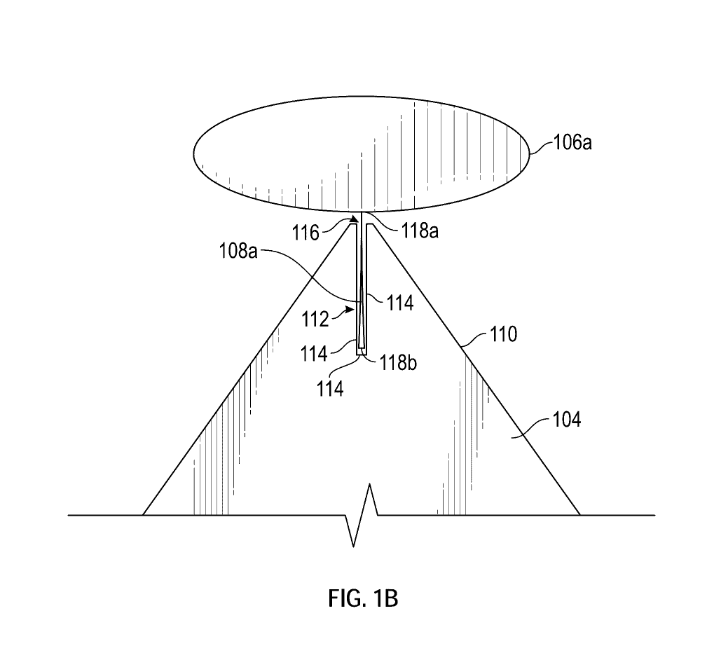

FIGS. 1A and 1B are schematic diagrams showing an example antenna array system;

FIG. 1B shows a partial close-up view of the example antenna array system shown in FIG. 1A.

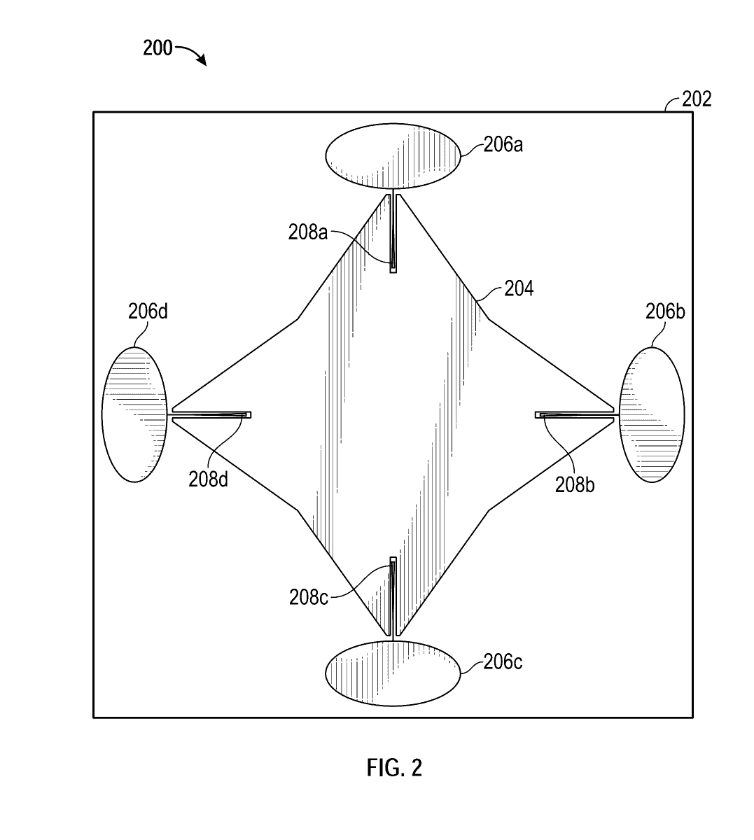

FIG. 2 is a schematic diagram showing another example antenna array system.

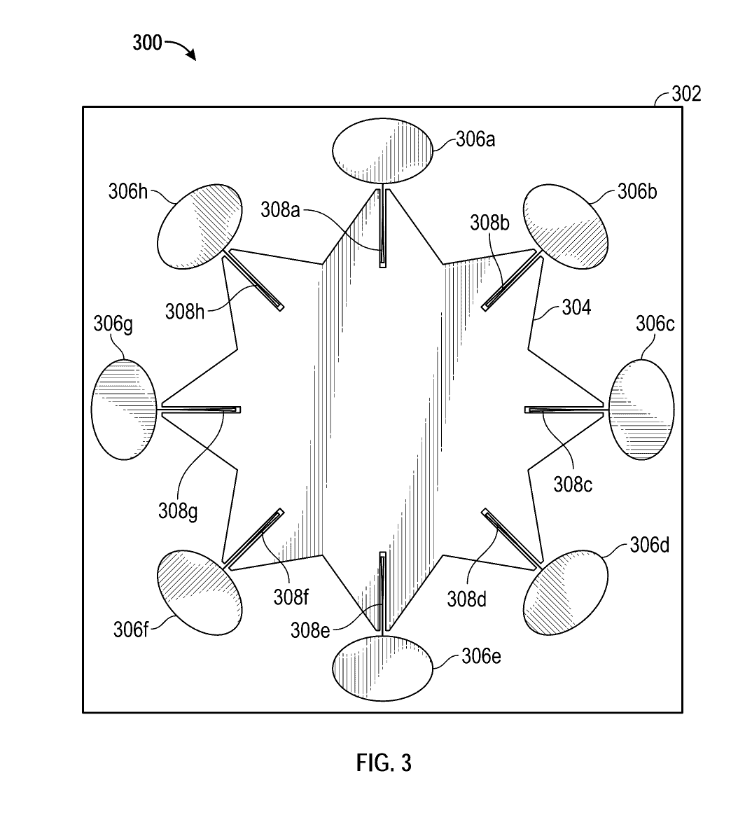

FIG. 3 is a schematic diagram showing another example antenna array system.

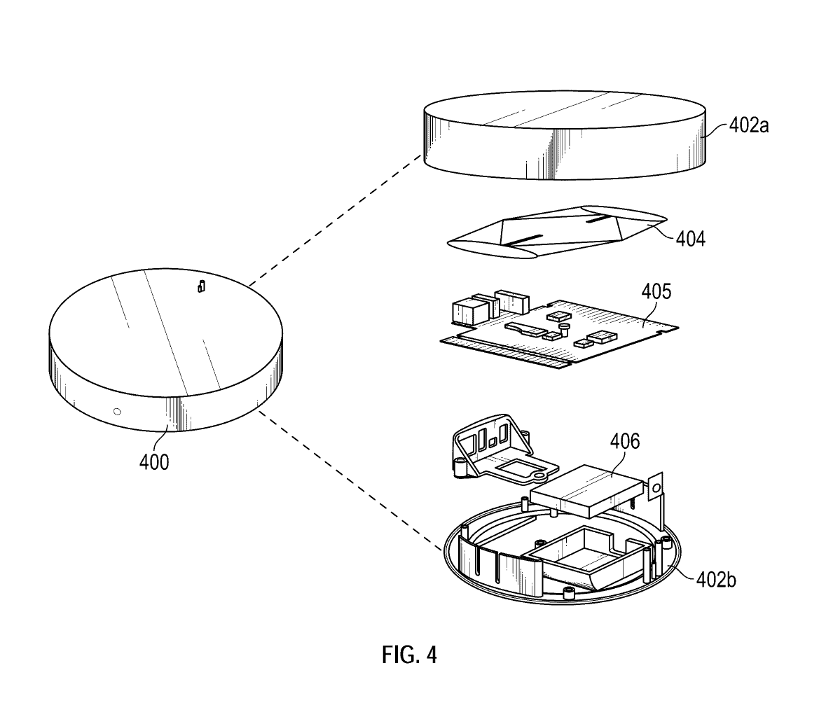

FIG. 4 is a diagram showing an example wireless sensor device.

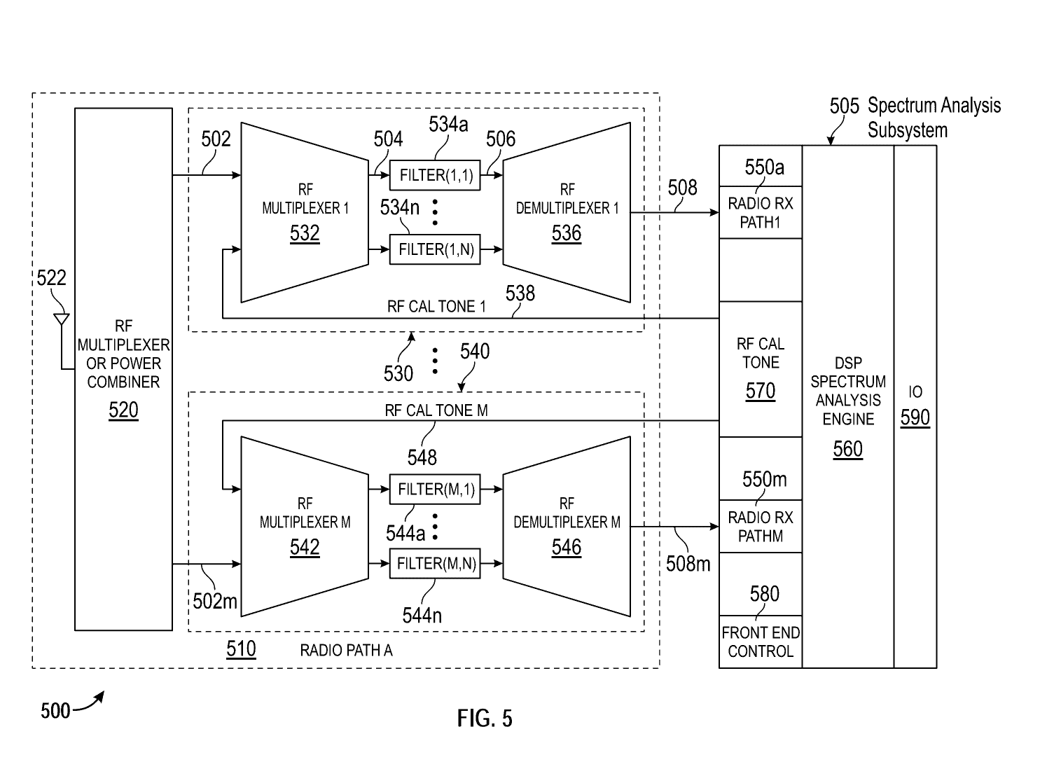

FIG. 5 is a block diagram showing an example signal path in a wireless sensor device.

### DETAILED DESCRIPTION

In some aspects of what is described here, an antenna system can be used for spectrum sensing, cognitive radio or a combination of these and other applications. In some examples, a wireless sensor device includes an Ultra-Wide-Band antenna array system (UWBAA) or another type of antenna array system.

In some of the examples described here, an antenna array system includes multiple omni-directional ultra-wide-band (UWB) monopole antennas arranged in a circular manner or another type of arrangement. Each of the UWB monopole antennas can include, for example, a patch, a feed and a ground plane. The feed provides electromagnetic coupling between the ground plane and the patch to transfer signals between them, for instance, to excite the patch. In some implementations, the feeds can be tapered or otherwise configured to operate as impedance transformers between the patches and the ground plane.

As a specific example, a UWB monopole antenna can include an elliptical patch, a trapeziform ground plane and a linearly-tapered co-planar waveguide feed. The monopole elliptical patches can be constructed, for example, in a planar UWBAA (P-UWBAA) format, where each elliptical patch is constructed as a planar elliptical element printed on the substrate that supports the ground plane. As another example, the elliptical patches can be constructed in a three-dimensional UWBAA (3D-UWBAA) format, where each elliptical patch is constructed as a three dimensional metal object mounted on the substrate that supports the ground plane. In either of these example formats (P-UWBAA, 3D-UWBAA) or other formats, the linearly tapered co-planar waveguide (CPW) feed can be printed on the substrate that supports the ground plane. In some implementations, the patches and the ground plane can be printed on the same side of the substrate, or the patches and the ground plane can be printed on opposite sides of the substrate. Other types of patches, ground planes and feeds may be used.

The patches can be implemented as planar or three-dimensional structures, each of which may provide advantages in some antenna array systems. In some cases, a planar configuration (e.g., the P-UWBAA format described above, or another planar format) can reduce the cost of constructing the antenna array system, accommodate integration of the antenna array system into a smaller-sized housing or other enclosure, or provide other advantages. In some cases, a three-dimensional configuration (e.g., the 3D-UWBAA format described above, or another three-dimensional format) can reduce the planar extent of the antenna array system, allow the antenna array system to fit into enclosures that are smaller or have different dimensions, reduce the cost of the overall system or device (e.g., by reducing the size of a printed circuit board shared with other elements), or provide other advantages.

In both planar and three-dimensional formats, the ground plane of the antenna array system can also provide advantages. For example, when the antenna array system operates in a housing or other enclosure, other circuit boards in the enclosure may overlap with the ground plane and have minimal effect on the performance of the antenna array system. As another example, the ground plane can be shared with other circuit board components in a device, which may further reduce the overall size of the device. In some of the antenna array system configurations described here (e.g., with two or four elliptical patches), the ground plane can have a trapezoidal shape that accommodates the feed and patch elements, for instance, at the corners of a rectangular printed circuit board.

In some implementations, the feed elements of the monopole antennas can also provide advantages. For example, the feeds can be implemented as symmetrically arranged CPW lines that are all aimed towards the center of the ground plane. These and other symmetrical arrangements may reduce or eliminate phase misalignment or other unwanted noise effects.

FIGS. 1A, 2 and 3 show examples of antenna array systems. Each of these examples can be implemented to provide ultra-wide-band (UWB) properties such as, for example, high data rate, low power consumption and low cost. In some implementations, each of the example antenna array systems can be operated at multiple distinct frequencies or in multiple distinct operating bands. For instance, a single antenna array system may be used to communicate with multiple distinct wireless networks, according to multiple distinct wireless standards, or in multiple distinct bands of licensed or unlicensed spectrum. In some implementations, an antenna array system can be configured (e.g., by tuning the dimensions and geometry of the conductive components) to operate over a wide range of frequencies, such as, for example, 600 MHz to 6 GHz or another frequency range.

In the examples shown in FIGS. 1A, 2 and 3, each antenna array system includes multiple monopole antennas that share a common ground plane. Each monopole antenna includes a single radiator element that is coupled to the ground plane by a feed. In the examples shown in FIGS. 1A, 2 and 3, the radiator element is implemented as an elliptical patch and the feed is implemented as a co-planar waveguide (CPW) feedline. A monopole antenna may include another type of radiator element (e.g., a patch having a different shape, etc.) and another type of feed (e.g., a microstrip feedline, etc.).

The example antenna array systems shown in FIGS. 1A, 2 and 3 can be constructed, for example, by forming the conductive components on the surface of a dielectric substrate. In some cases, the planar substrate is received, for instance, with a clean substrate surface. The ground plane, the feeds and the patches can be formed on the substrate surface in parallel or in any order, for instance, by a fabrication process or series of fabrication steps. For instance, conductive components can be formed on the substrate surface by fabrication techniques that include deposition processes, etching processes, etc. The patches can be coupled to the feeds, for example, by forming contact between them, by connecting a conductive lead between them, etc. In some cases, the patches are formed as planar elements on the substrate surface. In some cases, the patches are three-dimensional elements that are mounted on or connected to the substrate surface.

FIG. 1A is a schematic diagram showing an example antenna array system 100. The example antenna array system 100 shown in FIG. 1A includes an array of exactly two monopole antennas, and can be used in a wireless device to communicate (transmit, receive, or both) wireless signals to or from another device or system. In some instances, the antenna array system 100 can be used in a wireless sensor device to detect RF signals exchanged in a wireless communication network (e.g., a cellular voice or data network, a Wi-Fi network, etc.).

The example antenna array system 100 shown in FIG. 1A includes a substrate 102, a ground plane 104, patches 106a, 106b and feeds 108a, 108b. An antenna array system may include additional or different features, and the components of an antenna array system can be arranged as shown in FIG. 1A or in another manner. The example antenna array system 100 is a planar system that includes planar components. For instance, the example antenna array system 100 may be implemented as a printed circuit board or a similar type of structure in which the height dimension (out of page) of the structure is small (e.g., ⅕th, 1/10th, 1/20th or less) compared to the largest lateral dimension (in the plane of the page). In some instances, the example antenna array system 100 can be implemented as a non-planar structure, for example, the antenna array system 100 may be modified to include three-dimensional patches or other types of non-planar elements.

The example substrate 102 is a planar structure made of insulative material that supports the ground plane 104, the patches 106a, 106b, and the feeds 108a, 108b. In some implementations, the substrate 102 can include glass, plastic, fiber, resin, composites or other types of insulative material. In the example shown, the ground plane 104, the patches 106a, 106b, and the feeds 108a, 108b are conductive components that are all supported on a common surface of the substrate 102. The conductive components can be implemented as thin, planar structures, for example, having a height on the order of 1 millimeter, and having length and width dimensions on the order of 50-150 millimeters. The dimensions of the conductive components can be determined, for instance, based on the desired operating parameters (e.g., frequency, bandwidth, gain, efficiency, impedance, radiation pattern, etc.) of the antenna array system 100. In some implementations, the conductive components can be made of copper, gold or other types of conductive materials. In some implementations, the substrate 102 may support additional or different components, and one or more of the components may be supported on the opposite side of the substrate 102.

The example antenna array system 100 includes two monopole antennas on the substrate 102. A first monopole antenna includes the first patch 106a, the first feed 108a and the ground plane 104 about the first feed 108a. A second monopole antenna includes the second patch 106b, the second feed 108b and the ground plane 104 about the second feed 108b. The example antenna array system 100 can be modified to include additional monopole antennas, for instance, as shown in FIGS. 2 and 3, or in another manner. In some implementations, the monopole antennas in an antenna array system are redundant, such that each monopole antenna is a copy of the others and is configured to operate in the same frequency range. In some implementations, the monopole antennas in an antenna array are disparate, such that at least one monopole antenna is different from another monopole antenna in the array and is configured to operate in a different frequency range. In the example shown in FIG. 1A, both of the monopole antennas are configured to transmit and receive electromagnetic signals in the range of 600 MHz to 6 GHz.

The example ground plane 104 shown in FIG. 1A is a planar conductor supported on the surface of the substrate 102. The example ground plane 104 has a symmetrical diamond shape defined by an outer boundary of the ground plane 104. The example ground plane 104 includes two slots that extend inwardly from the outer boundary of the ground plane 104. The slots each include slot sides that define an interior region of the slot, and each of the feeds 108a, 108b resides in a respective one of the slots. The patches 106a, 106b reside outside the slots in an exterior area beyond the outer boundary of the ground plane 104, and each slot includes an opening between the interior region of the slot and the exterior area. An example of a slot and related features (e.g., slot opening, interior region, slot sides) is shown in FIG. 1B. The ground plane 104 may include other types of slots. In the example shown in FIG. 1A, the openings of the slots are distributed uniformly about the outer boundary of the ground plane 104. In particular, the slots are located at opposite sides of the ground plane (zero degrees (0°) and 180 degrees) (180°) with respect to the center of the ground plane 104) and have opposite orientations.

The example patches 106a, 106b shown in FIG. 1A are planar conductors supported on the surface of the substrate 102. The example patches 106a, 106b each have an elliptical shape that is defined by an outer boundary of the patch. The elliptical shape of each patch is an elongated circular shape that has two axes of symmetry. In some cases, the elliptical shape of a patch can be an exact ellipse (e.g., (x/a)²+(y/a)²=1), or the elliptical shape of the patch can be substantially elliptical while deviating from an exact ellipse. In some cases, the patches 106a, 106b and have another shape that is not elliptical. For instance, an antenna array system may include patches that are circular, square, rectangular, pentagonal, hexagonal, or another regular or irregular shape.

The example feeds 108a, 108b shown in FIG. 1A are planar conductors supported on the surface of the substrate 102. The feeds 108a, 108b each have an elongate shape and a linearly-tapered width. Each of the feeds 108a, 108b resides in a respective one of the slots and is separated from the ground plane 104 by a gap, such that there is a clearance space between the feed and the ground plane 104. The first feed 108a is electromagnetically coupled between the ground plane 104 and the first patch 106a; the second feed 108b is electromagnetically coupled between the ground plane 104 and the second patch 106b. Each of the feeds has a first end that is condutively coupled to its respective patch, and a second end that resides in the slot nearest its respective patch. In the example shown, the width of each feed increases linearly from one end (closest to the patch) to the other end (which resides in the slot). Each of the feeds 108a, 108b forms a coplanar waveguide (CPW) with the ground plane 104, and operates to transfer electromagnetic signals between the patches 106a, 106b and the ground plane 104.

FIG. 1B shows a partial close-up view of the example antenna array system 100. In particular, FIG. 1B shows the first feed 108a, the first patch 106a and the portion of the ground plane 104 adjacent to the first patch 106a. The second feed 108b, the second patch 106b and the portion of the ground plane 104 adjacent to the second patch 106b have the same features and properties.

As shown in FIG. 1B, a slot 112 extends into the ground plane 104 from an opening 116 in the outer boundary 110 of the ground plane 104. In the example shown, the slot 112 has three slot sides 114 that define a rectangular interior region. In other examples, the interior region of the slot 112 can have another shape, which can be defined by one or more interior sides of the ground plane 104. Also shown in FIG. 1B, the feed 108a has an elongate shape that extends from a first end 118b in the interior region of the slot to a second end 118a in the exterior area beyond the outer boundary 110 of the ground plane 104. In the example shown, the feed 108a is linearly-tapered, having a width that decreases linearly from the first end 118b to the second end 118a. In some instances, the tapered width of the feed 108a allows the feed 108a to act as an impedance transformer between the patch 106a and the ground plane 104.

As shown in FIG. 1B, a gap is defined between the ground plane 104 and the feed 108a. In particular, the gap is defined between the slot sides 114 and the outer boundary of the feed 108a. In the example shown, the gap provides a clearance space between the ground plane 104 and the feed 108a within the slot 112, and the width of the gap varies along the length of the feed 108a due to the tapered width of the feed 108a. In some cases, the gap can have another size or shape.

The example feed 108a shown in FIG. 1B is conductively coupled to the patch 106a at the second end 118a, for instance, by a direct contact or other connection between the feed 108a and the patch 106a in the exterior area. The example feed 108a shown in FIG. 1B is coupled to the ground plane 104 to transfer signals between the patch 106a and the ground plane 104. In the example shown, the feed 108a operates as a CPW feedline to transfer signals between the patch 106a and the ground plane 104. A feed can transfer signals between a patch and a ground plane in another manner.

FIG. 2 is a block diagram showing an example antenna array system 200. The example antenna array system 200 shown in FIG. 2 includes an array of exactly four monopole antennas, and can be used in a wireless device to communicate (transmit, receive, or both) wireless signals to or from another device or system. In some instances, the antenna array system 200 can be used in a wireless sensor device to detect RF signals exchanged in a wireless communication network (e.g., a cellular voice or data network, a Wi-Fi network, etc.).

The example antenna array system 200 shown in FIG. 2 includes a substrate 202, a ground plane 204, four patches 206a, 206b, 206c, 206d and four feeds 208a, 208b, 208c, 208d. In some implementations, the antenna array system 200 and its components shown in FIG. 2 are similar to the example antenna array system 100 and its components shown in FIGS. 1A and 1B. For instance, the example antenna array system 200 is a planar system that includes planar components. In some instances, the example antenna array system 200 can be implemented in another manner. For example, the antenna array system 200 may be implemented as a non-planar structure that includes three-dimensional patches or other non-planar components.

The example substrate 202 is a planar structure made of insulative material that supports the ground plane 204, the patches 206a, 206b, 206c, 206d and the feeds 208a, 208b, 208c, 208d. The example antenna array system 200 includes four monopole antennas on the substrate 202. A first monopole antenna includes the first patch 206a, the first feed 208a and the ground plane 204 about the first feed 208a. A second monopole antenna includes the second patch 206b, the second feed 208b and the ground plane 204 about the second feed 208b. A third monopole antenna includes the third patch 206c, the third feed 208c and the ground plane 204 about the third feed 208c. A fourth monopole antenna includes the fourth patch 206d, the fourth feed 208d and the ground plane 204 about the fourth feed 208d.

The example ground plane 204 shown in FIG. 2 is a planar conductor supported on the surface of the substrate 202. The example ground plane 204 has a symmetrical shape defined by an outer boundary of the ground plane 204. The example ground plane 204 includes four slots that extend inwardly from the outer boundary of the ground plane 204. The slots each include slot sides that define an interior region of the slot, and each of the feeds 208a, 208b, 208c, 208d resides in a respective one of the slots. The patches 206a, 206b, 206c, 206d reside outside the slots in an exterior area beyond the outer boundary of the ground plane 204, and each slot includes an opening between the interior region of the slot and the exterior area. In some cases, each of the slots and related features (e.g., slot opening, interior region, slot sides) can be implemented similar to the example shown in FIG. 1B. The ground plane 204 may include other types of slots. In the example shown in FIG. 2, the openings of the slots are distributed uniformly about the outer boundary of the ground plane 204. In particular, the slots are located at four sides of the ground plane (zero degrees (0°), ninety degrees (90°), 180 degrees (180°), and 270 degrees) (270°) with respect to the center of the ground plane 204) and have four distinct orientations.

The example patches 206a, 206b, 206c, 206d shown in FIG. 2 are planar conductors supported on the surface of the substrate 202. The example patches 206a, 206b, 206c, 206d each have an elliptical shape that is defined by an outer boundary of the patch. The example feeds 208a, 208b, 208c, 208d shown in FIG. 2 are planar conductors supported on the surface of the substrate 202. The feeds 208a, 208b, 208c, 208d each have an elongate shape and a linearly-tapered width. Each of the feeds 208a, 208b, 208c, 208d resides in a respective one of the slots and is separated from the ground plane 204 by a gap, which provides a clearance space between the feed and the ground plane 204. Each of the feeds 208a, 208b, 208c, 208d is electromagnetically coupled between the ground plane 204 and a respective one of the patches 206a, 206b, 206c, 206d. In the example shown, each of the feeds has a first end that is condutively coupled to its respective patch, and a second end that resides in the slot nearest its respective patch.

FIG. 3 is a block diagram showing an example antenna array system 300. The example antenna array system 300 shown in FIG. 3 includes an array of exactly eight monopole antennas, and can be used in a wireless device to communicate (transmit, receive, or both) wireless signals to or from another device or system. In some instances, the antenna array system 300 can be used in a wireless sensor device to detect RF signals exchanged in a wireless communication network (e.g., a cellular voice or data network, a Wi-Fi network, etc.).

The example antenna array system 300 shown in FIG. 3 includes a substrate 302, a ground plane 304, eight patches 306a, 306b, 306c, 306d, 306e, 306f, 306g, 306h and eight feeds 308a, 308b, 308c, 308d, 308e, 308f, 308g, 308h. In some implementations, the antenna array system 300 and its components shown in FIG. 3 are similar to the example antenna array system 100 and its components shown in FIGS. 1A and 1B. For instance, the example antenna array system 300 is a planar system that includes planar components. In some instances, the example antenna array system 300 can be implemented in another manner. For example, the antenna array system 300 may be implemented as a non-planar structure that includes three-dimensional patches or other non-planar components.

The example substrate 302 is a planar structure made of insulative material that supports the ground plane 304, the patches 306a, 306b, 306c, 306d, 306e, 306f, 306g, 306h and the feeds 308a, 308b, 308c, 308d, 308e, 308f, 308g, 308h. The example antenna array system 300 includes eight monopole antennas on the substrate 302. Each monopole antenna includes one of the patches, one of the feeds and the ground plane 304 about the feed.

The example ground plane 304 shown in FIG. 3 is a planar conductor supported on the surface of the substrate 302. The example ground plane 304 has a symmetrical shape defined by an outer boundary of the ground plane 304. The example ground plane 304 includes eight slots that extend inwardly from the outer boundary of the ground plane 304. The slots each include slot sides that define an interior region of the slot, and each of the feeds 308a, 308b, 308c, 308d, 308e, 308f, 308g, 308h resides in a respective one of the slots. The patches 306a, 306b, 306c, 306d, 306e, 306f, 306g, 306h reside outside the slots in an exterior area beyond the outer boundary of the ground plane 304, and each slot includes an opening between the interior region of the slot and the exterior area. In some cases, each of the slots and related features (e.g., slot opening, interior region, slot sides) can be implemented similar to the example shown in FIG. 1B. The ground plane 304 may include other types of slots. In the example shown in FIG. 3, the openings of the slots are distributed uniformly about the outer boundary of the ground plane 304. In particular, the slots are located at eight sides of the ground plane (zero degrees (0°), forty-five degrees (45°), ninety degrees (90°), 135 degrees (135°), 180 degrees (180°), 225 degrees (225°), 270 degrees (270°) and 315 degrees (315°) with respect to the center of the ground plane 304) and have eight distinct orientations.

The example patches 306a, 306b, 306c, 306d, 306e, 306f, 306g, 306h shown in FIG. 3 are planar conductors supported on the surface of the substrate 302. The example patches 306a, 306b, 306c, 306d, 306e, 306f, 306g, 306h each have an elliptical shape that is defined by an outer boundary of the patch. The example feeds 308a, 308b, 308c, 308d, 308e, 308f, 308g, 308h shown in FIG. 3 are planar conductors supported on the surface of the substrate 302. The feeds 308a, 308b, 308c, 308d, 308e, 308f, 308g, 308h each have an elongate shape and a linearly-tapered width. Each of the feeds 308a, 308b, 308c, 308d, 308e, 308f, 308g, 308h resides in a respective one of the slots and is separated from the ground plane 304 by a gap that provides a clearance space between the feed and the ground plane 304. Each of the feeds 308a, 308b, 308c, 308d, 308e, 308f, 308g, 308h is electromagnetically coupled between the ground plane 304 and a respective one of the patches 306a, 306b, 306c, 306d, 306e, 306f, 306g, 306h. In the example shown, each of the feeds has a first end that is conductively coupled to its respective patch, and a second end that resides in the slot nearest its respective patch.

FIG. 4 is a block diagram showing an example wireless sensor device 400. An assembled view of the wireless sensor device 400 is shown on the left in FIG. 4, and an exploded view of the wireless sensor device 400 is shown on the right in FIG. 4. As shown in the exploded view, the wireless sensor device 400 includes a housing member 402a, an antenna array system 404, a radio frequency (RF) processor system 405, a power supply 406 and another housing member 402b. A wireless sensor device may include additional or different features and components, and the components can be arranged in another manner.

The example wireless sensor device 400 is a compact, portable device that can be used to sense wireless signals and analyze wireless spectrum usage. In some implementations, the wireless sensor device 400 is designed to operate with low power consumption (e.g., around 0.1 to 0.2 Watts or less on average). In some implementations, the wireless sensor device 400 can be smaller than a typical personal computer or laptop computer and can operate in a variety of environments. In some instances, the wireless sensor device 400 can operate in a wireless sensor network or another type of distributed system that analyzes and aggregates wireless spectrum usage over a geographic area. For example, in some implementations, the wireless sensor device 400 can be used as described in U.S. Pat. No. 9,143,168, entitled, “Wireless Spectrum Monitoring and Analysis,” or the wireless sensor device 400 can be used in another type of environment or operate in another manner.

In some implementations, the wireless sensor device 400 can detect signals exchanged according to a wireless communication standard (e.g., for a cellular network), although the wireless sensor device itself is not part of the cellular network. In some instances, the wireless sensor device 400 monitors RF signals by “listening” or “watching” for RF signals over a broad range of frequencies and processing the RF signals that it detects. There may be times when no RF signals are detected, and the wireless sensor device 400 may process RF signals (e.g., from time to time or continuously) as they are detected in the local environment of the wireless sensor device 400.

As shown in FIG. 4, the example wireless sensor device 400 has a generally cylindrical shape that is defined by the housing members 402a, 402b. In the example shown, the upper housing member 402a mates with the lower housing member 402B to form a housing that houses the antenna array system 404, the RF processor system 405 and the power supply 406. The components of the wireless sensor device 400 can be secured to each other, for instance, by screws, clips, threads or other types of fasteners. The housing members 402a, 402b can be made of plastic, composites or other types of materials.

The antenna array system 404 shown in FIG. 4 can be implemented according to any of the example antenna array systems shown in FIGS. 1A, 2 and 3, or the antenna array system 404 can be implemented in another manner. In the example shown, the antenna array system 404 is a planar structure that includes a planar substrate with planar metal elements printed on a top surface of the substrate. In this example, the planar format of the antenna array system allows the wireless sensor device 400 to be constructed efficiently and in a compact manner. As shown in FIG. 4, the ground plane in the center of the substrate overlaps vertically with the RF processor system 405 and other components in the wireless sensor device 400. In some implementations, one or more of the circuits in the RF processor system 405 shares the ground plane of the antenna array system 404.

The antenna array system 404 is communicatively coupled with the RF processor system 405, for example, by wires, leads, contacts or another type of electromagnetic coupling that allows the antenna array system 404 and the RF processor system 405 to exchange RF signals. In some instances, the antenna array system 404 wirelessly receives RF signals from the electromagnetic environment of the wireless sensor device 400 and transfers the RF signals to the RF processor system 405 to be processed (e.g., digitized, analyzed, stored, retransmitted, etc.). In some instances, the antenna array system 404 receives RF signals from the RF processor system 405 and wirelessly transmits the received FR signals from the wireless sensor device 400.

The example RF processor system 405 can include one or more chips, chipsets, or other types of data processors that are configured to process RF signals. For example, the RF processor system 405 may include one or more chips that are configured to identify and analyze data encoded in RF signals by demodulating and decoding the RF signals transmitted according to various wireless communication standards. In some implementations, the RF processor system 405 is configured to monitor and analyze signals that are formatted according to one or more communication standards or protocols, for example, 2G standards such as Global System for Mobile (GSM) and Enhanced Data rates for GSM Evolution (EDGE) or EGPRS; 3G standards such as Code division multiple access (CDMA), Universal Mobile Telecommunications System (UMTS), and Time Division Synchronous Code Division Multiple Access (TD-SCDMA); 4G standards such as Long-Term Evolution (LTE) and LTE-Advanced (LTE-A); wireless local area network (WLAN) or WiFi standards such as IEEE 802.11, Bluetooth, near-field communications (NFC), millimeter communications; or multiple of these or other types of wireless communication standards. In some cases, the RF processor system 405 is capable of extracting all available characteristics, synchronization information, cells and services identifiers, quality measures of RF, Physical Layers of wireless communication standards and other information. In some implementations, the RF processor system 405 is configured to process other types of wireless communication (e.g., non-standardized signals and communication protocols).

In some implementations, the RF processor system 405 can perform various types of analyses in the frequency domain, the time domain, or both. In some cases, the RF processor system 405 is configured to determine bandwidth, power spectral density, or other frequency attributes of detected signals. In some cases, the RF processor system 405 is configured to perform demodulation and other operations to extract content from the wireless signals in the time domain such as, for example, signaling information included the wireless signals (e.g., preambles, synchronization information, channel condition indicator, SSID/MAC address of a WiFi network). The RF processor system 405 and the antenna system 404 can operate based on electrical power provided by the power supply 406. For instance, the power supply 406 can include a battery or another type of component that provides an AC or DC electrical voltage to the RF processor system.

FIG. 5 is a block diagram showing an example signal path 500 that can be implemented, for instance, in the wireless sensor device 400 shown in FIG. 4 or another type of device. Other types of signal paths may be used for processing signals in a wireless sensor device. The example signal path 500 shown in FIG. 5 includes an RF interface 510 (denoted as “Radio Path A” in FIG. 5) and a spectrum analysis subsystem 505. A signal path can include additional or different features, which may be configured in another manner. In some cases, the signal path 500 can perform all operations for monitoring and analyzing wireless signals in a wireless sensor device. For example, the signal path 500 can perform functions of a wireless receiver such as demodulation, equalization, channel decoding, etc. The signal path 500 can support signal reception of various wireless communication standards and access the spectrum analysis subsystem 505 for analyzing the wireless signals.

In the example shown, the RF interface 510 can include a wideband or narrowband front-end chipset for detecting and processing RF signals. For example, the RF interface 510 can be configured to detect RF signals in a wide spectrum of one or more frequency bands, or a narrow spectrum within a specific frequency band of a wireless communication standard. In some implementations, the signal path 500 can include one or more RF interfaces 510 to cover the spectrum of interest.

In the example shown in FIG. 5, the RF interface 510 includes an antenna system 522, an RF multiplexer 520 or power combiner (e.g., an RF switch), and one or more signal processing paths (e.g., “path 1” 530, . . . , “path M” 540). The antenna system 522 can be implemented as any of the example antenna array systems 100, 200, 300 shown in FIGS. 1A, 2 and 3, or the antenna systems 522 can be implemented in another manner. The example antenna system 522 in FIG. 5 is connected to an RF multiplexer 520. In some implementations, the RF interface 510 can be configured to use the antenna system 522 for detecting the RF signals based on single-input single-output (SISO), single-input and multiple-output (SIMO), multiple-input and single-output (MISO), or multiple-input and multiple-output (MIMO) technologies.

In some implementations, an RF signal in the local environment of a wireless sensor device can be picked up by the antenna system 522 and input into the RF multiplexer 520. Depending on the frequency of the RF signal that needs to be analyzed, the signal 502 output from the RF multiplexer 520 can be routed to one of the processing paths (i.e., “path 1” 530, . . . , “path M” 540, where M is an integer). Each path can include a distinct frequency band. For example, “path 1” 530 may be used for RF signals between 1 GHz and 1.5 GHz, while “path M” may be used for RF signals between 5 GHz and 6 GHz. The multiple processing paths may have a respective central frequency and bandwidth. The bandwidths of the multiple processing paths can be the same or different. The frequency bands of two adjacent processing paths can be overlapping or disjointed. In some implementations, the frequency bands of the processing paths can be allocated or otherwise configured based on the assigned frequency bands of different wireless communication standards (e.g., GSM, LTE, WiFi, etc.). For example, it can be configured such that each processing path is responsible for detecting RF signals of a particular wireless communication standard. As an example, “path 1” 530 may be used for detecting LTE signals, while the “path M” 540 may be used for detecting WiFi signals.

Each processing path (e.g., “processing path 1” 530, “processing path M” 540) can include one or more RF passive and RF active elements. For example, the processing path can include an RF multiplexer, one or more filters, an RF de-multiplexer, an RF amplifier, and other components. In some implementations, the signals 502, 502m output from the RF multiplexer 520 can be applied to a multiplexer in a processing path (e.g., “RF multiplexer 1” 532, . . . , “RF multiplexer M” 542). For example, if “processing path 1” 530 is selected as the processing path for the signal 502, the signal 502 can be fed into “RF multiplexer 1” 532. The RF multiplexer can choose between the signal 502 coming from the first RF multiplexer 520 or the RF calibration (cal) tone 538 provided by the spectrum analysis subsystem 505. The output signal 504 of “RF multiplexer 1” 532 can go to one of the filters, Filter(1,1) 534a, . . . , Filter (1,N) 534n, where N is an integer. The filters further divide the frequency band of the processing path into a narrower band of interest. For example, “Filter(1,1)” 534a can be applied to the signal 504 to produce a filtered signal 506, and the filtered signal 506 can be applied to “RF de-multiplexer 1” 536. In some instances, the signal 506 can be amplified in the RF de-multiplexer. The amplified signal 508 can then be input into the spectrum analysis subsystem 505.

Similarly, if “processing path M” 540 is selected as the processing path for the signal 502m, the signal 502m can be fed into “RF multiplexer M” 542. The RF multiplexer can choose between the signal 502m coming from the first RF multiplexer 520 or the RF calibration (cal) tone 548 provided by the spectrum analysis subsystem 505. The output signal of “RF multiplexer M” 542 can go to one of the filters, Filter(M,1) 544a, . . . , Filter (M,N) 544n, where N is an integer. In some instances, the output signal of the filters can be amplified in the RF de-multiplexer M 546. The amplified signal 508m can then be input into the spectrum analysis subsystem 505.

The spectrum analysis subsystem 505 can be configured to convert the detected RF signals into digital signals and perform digital signal processing to identify information based on the detected RF signals. The spectrum analysis subsystem 505 can include one or more SI radio receive (RX) paths (e.g., “Radio RX path 1” 550a, “Radio RX path M” 550m), a DSP spectrum analysis engine 560, an RF calibration (cal) tone generator 570, a front-end control module 880, and an I/O 890. The spectrum analysis subsystem 505 may include additional or different components and features.

In the example shown, the amplified signal 508 is input into “Radio RX path 1” 550a, which down-converts the signal 508 into a baseband signal and applies gain. The down-converted signal can then be digitalized via an analog-to-digital converter. The digitized signal can be input into the DSP spectrum analysis engine 560. The DSP spectrum analysis engine 560 can, for example, identify packets and frames included in the digital signal, read preambles, headers, or other control information embedded in the digital signal (e.g., based on specifications of a wireless communication standard), determine the signal power and SNR of the signal at one or more frequencies or over a bandwidth, channel quality and capacity, traffic levels (e.g., data rate, retransmission rate, latency, packet drop rate, etc.), or other parameters. The output (e.g., the parameters) of the DSP spectrum analysis engine 560 can be applied and formatted to the I/O 890, for example, for transmission of the parameters to the data processing system via one or more communication interfaces of the wireless sensor device.

The RF calibration (cal) tone generator 880 can generate RF calibration (cal) tones for diagnosing and calibration of the radio RX paths (e.g., “Radio RX path 1” 550a, . . . “Radio RX path M” 550m). The radio RX paths can be calibrated, for example, for linearity and bandwidth.

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable subcombination.

A number of embodiments have been described. Nevertheless, it will be understood that various modifications can be made. Accordingly, other embodiments are within the scope of the following claims.

What is claimed is:

1. An antenna array system comprising an array of monopole antennas, the antenna array system comprising:
a planar substrate comprising a substrate surface;
a ground plane residing on the substrate surface, the ground plane comprising an outer boundary and a plurality of slots extending inwardly from the outer boundary, each of the slots comprising slot sides that define an interior region of the slot;
a plurality of feeds residing on the substrate surface, the plurality of feeds residing in the plurality of slots and being separated from the ground plane by a gap, each of the feeds extending from a first end in the interior region of a respective one of the slots to a second end in an exterior area beyond the outer boundary of the ground plane; and
a plurality of elliptical patches, each of the elliptical patches coupled to a respective one of the plurality of feeds.

2. The antenna array system of claim 1, wherein each of the slots defines an opening between the interior region of the slot and the exterior area, and the openings of the plurality of slots are distributed uniformly about the outer boundary of the ground plane.

3. The antenna array system of claim 1, wherein each of the elliptical patches comprises a planar conductor residing on the substrate surface in the exterior area.

4. The antenna array system of claim 1, wherein each of the feeds comprises a planar conductor that has a width that is tapered from the first end to the second end.

5. The antenna array system of claim 1, configured to transmit and receive electromagnetic signals in the range of 600 MHz to 6 GHz.

6. The antenna array system of claim 1, comprising an array of two monopole antennas, each of the two monopole antennas comprising one of the feeds and one of the elliptical patches.

7. The antenna array system of claim 1, comprising an array of four monopole antennas, each of the four monopole antennas comprising one of the feeds and one of the elliptical patches.

8. The antenna array system of claim 1, comprising an array of eight monopole antennas, each of the eight monopole antennas comprising one of the feeds and one of the elliptical patches.

9. A wireless sensor device comprising:
a housing;
a radio frequency signal processor system residing in the housing; and
an antenna array system residing in the housing, coupled to the radio frequency signal processor system, and configured to communicate wirelessly with a wireless communication network, the antenna array system comprising:
a planar substrate comprising a substrate surface;
a ground plane residing on the substrate surface, the ground plane comprising an outer boundary and a plurality of slots extending inwardly from the outer boundary, each of the slots comprising slot sides that define an interior region of the slot;
a plurality of feeds residing on the substrate surface, the plurality of feeds residing in the plurality of slots and being separated from the ground plane by a gap, each of the feeds extending from a first end in the interior region of a respective one of the slots to a second end in an exterior area beyond the outer boundary of the ground plane; and
a plurality of elliptical patches, each of the elliptical patches coupled to a respective one of the plurality of feeds.

10. The wireless sensor device of claim 9, wherein each of the slots defines an opening between the interior region of the slot and the exterior area, and the openings of the plurality of slots are distributed uniformly about the outer boundary of the ground plane.

11. The wireless sensor device of claim 9, wherein each of the elliptical patches comprises a planar conductor residing on the substrate surface in the exterior area.

12. The wireless sensor device of claim 9, wherein each of the feeds comprises a planar conductor that has a width that is tapered from the first end to the second end.

13. The wireless sensor device of claim 9, wherein the wireless communication network comprises a cellular network, and the antenna array system is configured to receive cellular network signals formatted according to any of multiple distinct cellular network standards.

14. A method for constructing an antenna array system comprising an array of monopole antennas, the method comprising:
receiving a planar substrate comprising a substrate surface;
forming a ground plane on the substrate surface, the ground plane comprising an outer boundary and a plurality of slots extending inwardly from the outer boundary, each of the slots comprising slot sides that define an interior region of the slot;
forming a plurality of feeds on the substrate surface, the plurality of feeds residing in the plurality of slots and being separated from the ground plane by a gap, each of the feeds extending from a first end in the interior region of a respective one of the slots to a second end in an exterior area beyond the outer boundary of the ground plane; and
coupling a plurality of elliptical patches to the plurality of feeds, each of the elliptical patches being coupled to a respective one of the plurality of feeds.

15. The method of claim 14, wherein each of the slots defines an opening between the interior region of the slot and the exterior area, and the openings of the plurality of slots are distributed uniformly about the outer boundary of the ground plane.

16. The method of claim 14, wherein each of the elliptical patches comprises a planar conductor residing on the substrate surface in the exterior area.

17. The method of claim 14, wherein each of the feeds comprises a planar conductor that has a width that is tapered from the first end to the second end.

18. The method of claim 14, comprising forming an array of two monopole antennas, each of the two monopole antennas comprising one of the feeds and one of the elliptical patches.

19. The method of claim 14, comprising forming an array of four monopole antennas, each of the four monopole antennas comprising one of the feeds and one of the elliptical patches.

20. The method of claim 14, comprising forming an array of eight monopole antennas, each of the eight monopole antennas comprising one of the feeds and one of the elliptical patches.
